(19) United States
(12) Patent Application Publication
(10) Pub. No.: US 2025/0033598 A1
(43) Pub. Date: Jan. 30, 2025

(54) Control System With a Motor Vehicle

(71) Applicant: Bayerische Motoren Werke Aktiengesellschaft, Muenchen (DE)

(72) Inventors: Bernhard GASSER, Muenchen (DE); Daniel KNOBLOCH, Los Gatos, CA (US); Christian LEMKEMEYER, Muenchen (DE)

(21) Appl. No.: 18/785,081

(22) Filed: Jul. 26, 2024

(30) Foreign Application Priority Data
Jul. 27, 2023 (DE) 10 2023 120 044.5

(51) Int. Cl. B60R 25/24

(52) U.S. Cl. CPC B60R 25/24; B60R 2325/10

(57) ABSTRACT

A control system includes a motor vehicle with a first control apparatus and an infrastructure with a second control apparatus. The control apparatuses are configured to establish a wireless connection to one another and to carry out a bilateral authentication via the connection. The motor vehicle is configured to request a predefined function of the infrastructure via the connection; and the second control apparatus is configured to perform the requested function of the infrastructure if the function is enabled for control by way of the motor vehicle.

### BACKGROUND AND SUMMARY

The present invention relates to a control system with a motor vehicle. In particular, the invention relates to the control of an infrastructure for use by way of the motor vehicle.

An infrastructure is configured for use by way of a motor vehicle. The infrastructure can comprise, for example, a parking garage or a garage, in which the motor vehicle can be parked. The infrastructure can be secured against unauthorized use by means of an access control system. In order to use the infrastructure or to enable the infrastructure by way of the access control system, an electronically readable card, a remote control or an RFID token can be provided to a user of the motor vehicle. As an alternative, a computer program can also be used which the user can install on an on-board mobile device.

Different infrastructures are secured by means of access control systems which are different and in general are incompatible with one another. On board a motor vehicle which is intended to use a plurality of infrastructures, a plurality of cards, units or computer programs can accumulate which are each configured to control only one infrastructure. A selection or use of an authentication can be unpractical.

If a device is to be purchased or returned or if an authorization of the motor vehicle at one of the infrastructures is to be amended, an administration which is assigned to the infrastructure usually has to be used. An implementation of a desired amendment can be complicated and can be different between administrations of different infrastructures. A combination of a plurality of infrastructures in a group or the separation of an infrastructure into a plurality of infrastructures is usually not possible.

An object on which the present invention is based consists in the provision of improved technology for controlling an infrastructure which can be used by way of a motor vehicle. The invention achieves this object by means of the subjects of the independent claims. Dependent claims describe preferred embodiments.

A control system comprises a motor vehicle with a first control apparatus and an infrastructure with a second control apparatus. Here, the control apparatuses are configured to establish a wireless connection to one another and to perform a bilateral authentication via the connection. Furthermore, the motor vehicle is configured to request a predefined function of the infrastructure via the connection; and the second control apparatus is configured to perform the requested function of the infrastructure if the function is enabled for control by way of the motor vehicle.

The control system can augment a known control system which controls only the control of one function of a motor vehicle. In the known system, for example, a function can relate to locking or unlocking of the motor vehicle or a driving function. The function can be enabled after a bilateral authentication has taken place via a wireless interface between the motor vehicle and a mobile device. Should an authentication fail, the function cannot be used or cannot be triggered by the other side. The known control system can implement a digital car key and, for example, can operate in accordance with a publicly accessible specification of the Car Connectivity Consortium.

It has been recognized that a system of this type can advantageously be augmented by way of definition of a new role. In the control system which is proposed herein, a role for infrastructure is additionally provided. Infrastructure is preferably considered herein to mean a facility which is attached in a stationary manner. The infrastructure can comprise a building and can be connected fixedly to the ground. The infrastructure can be used by way of a motor vehicle. The infrastructure preferably comprises a driving or parking surface, a building or a functional facility, for example a charging station for an electric energy store of a motor vehicle. The infrastructure or access to it can be controlled by way of a mobile device or by way of a motor vehicle. The motor vehicle can bring about the control via the first control apparatus.

Universal access control to one or more infrastructures can advantageously be made possible by way of the new role for the infrastructure. For instance, it is possible for as many different infrastructures as desired to be controlled on the basis of a technology which is already established. Only the first control apparatus has to be attached on board the motor vehicle; carrying further units, cards or tokens can be dispensed with. The use of the infrastructure can be simpler or more comfortable.

An administration of an authorization of the motor vehicle to use an infrastructure can be unified for a multiplicity of infrastructures. An authorization of the motor vehicle can be transferred from one to another infrastructure, or an infrastructure can be split into different individual infrastructures which can be treated differently in organizational terms, but can be controlled by means of the same control system in technical terms. The use of the infrastructure and the administration of authorizations can be unified in an improved manner and can be comfortable to use.

The function of the infrastructure preferably relates to the motor vehicle. For example, the function can comprise enabling or declining physical access of the motor vehicle to the infrastructure. The infrastructure can comprise, for example, a garage or a parking garage which is protected against use by way of a motor vehicle by means of a gate or a barrier. In a further embodiment, a duplex parking space can be controlled, in order to enable entry or exit of a motor vehicle.

Generally, the function can be controlled automatically by way of the motor vehicle when it drives close enough to the infrastructure, with the result that the connection can be established. As an alternative, the use of the function can be prepared automatically and can be triggered only by way of a person on board the motor vehicle, for example by pressing on a button. The function can also be prepared automatically and can be triggered automatically only when a predefined condition is met, for example that the motor vehicle is parked.

In a further embodiment, a component which is connected to the infrastructure can be controlled with regard to the motor vehicle. For example, an electric charging connection for charging an energy store of the motor vehicle can be established automatically when the motor vehicle approaches the infrastructure. To this end, the component can comprise a type of arm which can plug in the charging plug into a charging socket of the motor vehicle.

Conversely, the infrastructure can be configured to request a predefined function of the motor vehicle via the connection; wherein the first control apparatus is configured to perform the requested function of the motor vehicle if the function is enabled for control by way of the infrastructure. A function of the motor vehicle can thus be controlled by way of the infrastructure. In the control system, the role of the infrastructure can also enable the control of the motor vehicle.

For example, a standard air conditioning system of the motor vehicle can be activated at the request of the infrastructure, for instance if it is known that a user is approaching the motor vehicle. In another embodiment, a driving function of the motor vehicle can be controlled by means of the infrastructure. The infrastructure can comprise, for example, a parking lot, a parking garage or an underground garage. A path or a trajectory, on which the motor vehicle can be moved to a free parking space or to an exit, can be determined by means of the infrastructure. The infrastructure can control the motor vehicle to drive autonomously along the trajectory.

In another example, the infrastructure can transmit update data to the motor vehicle. Thus, for example, an update of map data or installed software can take place in an automated manner. The data can be stored at the infrastructure and can be provided to a multiplicity of motor vehicles.

Authentication preferably takes place by means of an asymmetric cryptographic method. Here, a private and a public key can be assigned to each of the two communications partners, for example the motor vehicle and the infrastructure. A reciprocal authentication can take place on the basis of a challenge/response method. A single transaction is preferably carried out, by means of which authentications can take place in both directions.

The control system can comprise, furthermore, an external location, from which a public key of a participant can be obtained. Moreover, an administration of authorizations can take place at the external location. For example, an authorization to use a predefined function of a first participant can be revoked by way of a second participant, by a corresponding information item being stored at the external location. The first participant which provides the function for control can obtain the amended information item from the external location and, as a consequence, can deny the performance of the function after a request by way of the second participant.

It is to be noted that fine granular authorizations can be stored at the external location. For example, the use of a function can be linked not only to a predefined participant, but rather also to predefined circumstances. Circumstances of this type can relate for instance to a time of day or, in the case of the motor vehicle, a driving speed.

The control system can comprise, furthermore, a mobile device; wherein the mobile device is configured to establish a wireless connection to the infrastructure and to perform a bilateral authentication via the connection; wherein enabling of a function of the infrastructure is controlled with regard to a request by way of the motor vehicle via the connection.

The mobile device can comprise, for example, a smartphone, a tablet computer or a personal computer. The mobile device is preferably the primary means for a user to manage an authorization of a motor vehicle to use a predefined function of an infrastructure. Here, modalities such as billing or an identification of the user can be clarified. In one embodiment, the user can manage an authorization only for a motor vehicle only when this user is authorized to use it.

A control apparatus for an infrastructure is configured to establish a wireless connection to a motor vehicle and to perform a bilateral authentication via the connection; to receive a request of a motor vehicle via the connection with regard to a function of the infrastructure; and to perform the requested function if the function is enabled for control by way of the motor vehicle. The control apparatus can comprise a second control apparatus which is described herein.

The control apparatus can comprise, furthermore, an actuator for controlling a function of the infrastructure. The function can relate to the motor vehicle. The actuator can enforce, for example, physical access control and can comprise a barrier, a gate, a fence or a similar device. As an alternative, the actuator can be configured to perform a predefined function on the motor vehicle, for example plugging a charging plug of an electric charging apparatus into a charging socket of the motor vehicle. The actuator can also be configured to provide predefined data or information to the motor vehicle. A request for the data can come from the motor vehicle, or the infrastructure can provide the data proactively to the motor vehicle.

In accordance with a further aspect, a first method comprises steps of generating a two-part digital key; providing a first part of the key to a motor vehicle; and providing a second part of the key to an infrastructure, with the result that a bilateral authentication between the motor vehicle and the infrastructure is possible on the basis of the two parts.

The key can be generated and provided, for example, by means of an external location. The external location can sign the parts and thus guarantee their authenticity. In order for it to be possible for the key to be generated, verification can be requested that a requesting location has the authorization to control the infrastructure or a predefined function. If, for example, a person requests the key, they can present verification about the ownership of the infrastructure. The transfer of the key or the part of the key to the motor vehicle preferably takes place wirelessly. A user of the motor vehicle can optionally be requested to accept a provided key, with the result that it can be used by the motor vehicle.

The generation of the key can also be performed by way of a further external location. For example, a manufacturer of a certain infrastructure, for instance garage gates, can operate an external location which is first of all considered to be owner of all provided infrastructures. If an infrastructure is sold to a person, a key for using a predefined function of the infrastructure can be established and provided. A part of the key which is to be provided to the motor vehicle can be transferred to a further external location which is responsible for the administration of digital keys for this motor vehicle.

In accordance with a further aspect, a second method for controlling a predefined function of an infrastructure comprises steps of establishing a wireless connection between a motor vehicle and an infrastructure, and bilateral authenticating via the connection; requesting a predefined function of the infrastructure by way of the motor vehicle; and performing the predefined function by way of the infrastructure if the function is enabled for control by way of the motor vehicle. As also in other cases, it is also the case here that the function is not controlled if an authentication fails.

The method can be performed by means of a control system described herein. Here, parts of the method can be fulfilled by way of different components of the control system. A component can comprise an electronic processing device, on which a part of the method in the form of a computer program product can run. To this end, the processing device can be of an electronic configuration and can comprise, for example, an integrated circuit, a programmable logic module or a programmable microcomputer. The method can be realized in the form of a configuration or as a computer program product with program code means for the processing device. The configuration or the computer program product can be stored on a computer-readable data storage medium. Features or advantages of the method can be transferred to the apparatus or vice versa.

The invention will now be described in greater detail with reference to the appended drawings.

### BRIEF DESCRIPTION OF THE DRAWINGS

FIG. 1 illustrates a control system;

FIG. 2 illustrates a flow chart of a first method; and

FIG. 3 illustrates a flow chart of a second method.

### DETAILED DESCRIPTION OF THE DRAWINGS

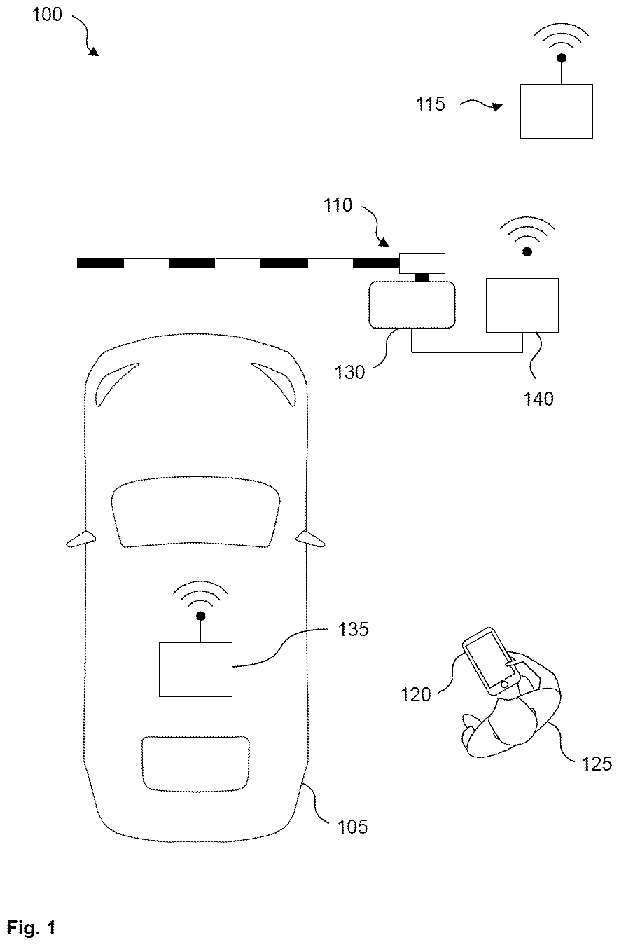

FIG. 1 shows a control system 100 which comprises a motor vehicle 105 and an infrastructure 110. Furthermore, an external location 115 is preferably provided. A mobile device 120 can be provided for use by way of a person 125. The motor vehicle 105, the infrastructure 110, the external location 115 and the mobile device 120 can also be called components or participants of the control system 100 herein.

The infrastructure 110 can comprise an actuator 130 which is configured in the present case by way of example as a barrier which can enable or block access of the motor vehicle 105 to a parking space or an entrance. Other types of actuators 130 are likewise possible.

A first control apparatus 135 is provided on board the motor vehicle 105, and a second control apparatus 140 is provided at the infrastructure 110. A control apparatus 135, 140 can comprise an electronic processing device which can be configured as a microcomputer. With regard to the control system 100 disclosed herein, the motor vehicle 105 can act by means of or by way of the first control apparatus 135, and the infrastructure 110 can act by means of or by way of the second control apparatus 140.

A communication between two participants 105, 110, 115, 120 of the control system usually presupposes establishing a wireless communications connection and successfully authenticating the two participants 105, 110, 115, 120 at the respective other participant 105, 110, 115, 120. The person 125 can also be authenticated with respect to the mobile device 120 before a communication with a participant 105, 110, 115, 120 can be controlled.

If one of the authentications does not proceed successfully, a requested function of another participant 105, 110, 115, 120 cannot be controlled. In this case, the communication is usually ended and the connection is disconnected.

In a known way, a function of the motor vehicle 105 can be controlled by means of the mobile device 120. It is proposed, in addition to the roles of the mobile device 120 and the motor vehicle 105, to give an additional role for the infrastructure 120 in the control system 100. A function of the infrastructure 110 can then be controlled by way of the motor vehicle 105 and optionally by way of the mobile device 120. Conversely, the infrastructure 110 can control a function of the motor vehicle 105. The infrastructure 110 can optionally also be controlled by means of the mobile device 120.

By means of the mobile device 120, the person can communicate with the external location 115 and in the process negotiate or set an authorization of the motor vehicle 105 to use a function of one of the participants 105, 110. Here, details can be recorded, and a payment for the use or provision of a predefined function of one of the participants 105, 110 can optionally be determined. It is to be noted that an authorization can also be controlled by another side, for example by a representative of the infrastructure 110.

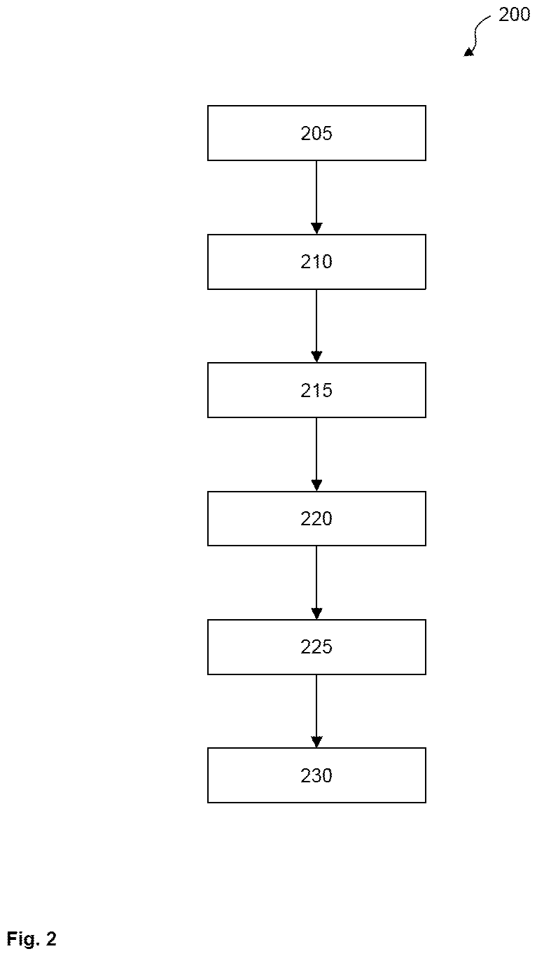

FIG. 2 shows a flow chart of a first method 200 which can preferably be performed by means of the control system 100. The first method serves to determine an authorization of a motor vehicle 105 to use a predefined function of an infrastructure 110.

In a step 205, a person 125 or external facility 115 can provide evidence that they have power of disposition over a predefined infrastructure 110. For example, a person 125 can show evidence about the purchase of the infrastructure 110 or a certificate which shows them as owner or operator.

In a step 210, the generation of a key can be requested. The digital key can then be generated in a step 215, and comprises a first and a second part. The first part can be provided in a step 220 to the infrastructure 110. This part can correspond to a private key of the infrastructure 120 in an asymmetric cryptographic method.

The second part of the key can be transferred in a step 225 to a further external location 115 which is responsible for administration of keys for the motor vehicle 105.

The external location 115 can provide the second part in a step 230 to the motor vehicle 105. The second part can correspond to a public key of the infrastructure 120 in an asymmetric cryptographic method. The part is preferably transmitted in a wireless manner. It is to be noted that the second part can also be transferred directly to the motor vehicle 105 by the facility which generates the key.

An operating person of the motor vehicle 105 is preferably requested to check the obtained key and to confirm its installation. After the confirmation, the key can be stored in a key store of the motor vehicle 105 and is available for authentication of the motor vehicle 105 with respect to the infrastructure 110.

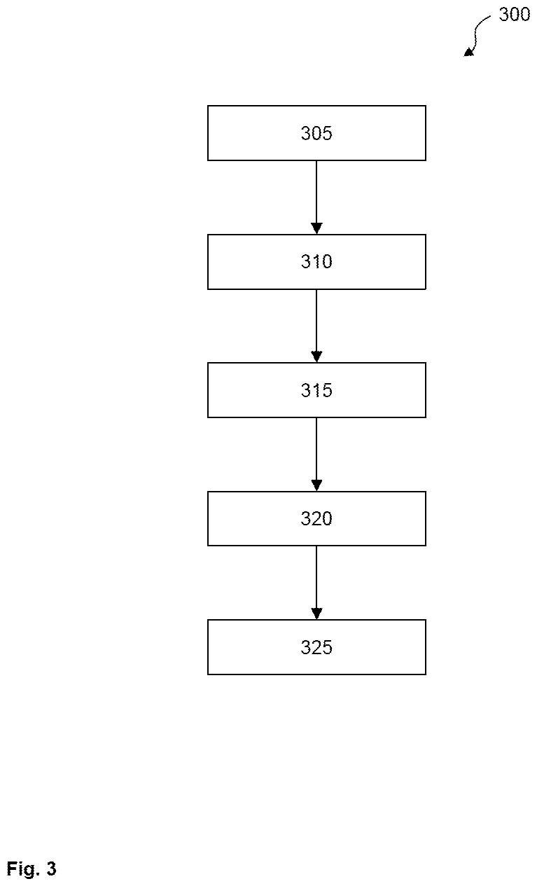

FIG. 3 shows a flow chart of a second method 300 for controlling a control system 100. In a step 305, a wireless connection can be established between the motor vehicle 105 and the infrastructure 110. This connection is also preferably based on known technologies such as UWB or BT-LE.

In a step 310, the motor vehicle 105 and the infrastructure 110 can authenticate one another mutually. Should one of the authentications fail, the first method 300 can end at this point. In a step 315, a predefined function of the infrastructure 110 can be requested by way of the motor vehicle 105. The request can be part of a transaction, by way of which the mutual authentications are processed in step 310.

A check can be carried out in a step 320 as to whether the motor vehicle 105 is authorized to use the function. If this is the case, the function can be performed in a step 325. Otherwise, the function cannot be performed.

The method 300 might also be performed in a modified way by way of the mobile device 120 instead of the motor vehicle 105. This would presuppose, however, that the mobile device 120 is always carried in order to use the infrastructure by way of the motor vehicle 105. The person 125 would possibly have to authenticate with respect to the mobile device 120, in order that the motor vehicle 105 can use the function of the infrastructure 110. This might be problematic, for example, if the person 125 is at the same time steering the motor vehicle 105. Automatic control of the function by way of the motor vehicle 105 might not take place in this way.

As a result of the defined role proposed herein of the infrastructure 110, the function can be used by way of the motor vehicle 105, without it being necessary for the mobile device 120 to be used. In one embodiment, not even the presence of the person 125 is necessary for use.

### LIST OF DESIGNATIONS

100 System
105 Motor vehicle
110 Infrastructure
115 External location
120 Mobile device
125 Person
130 Actuator
135 First control apparatus
140 Second control apparatus
200 First method
205 Authenticate
210 Request key generation
215 Generate key
220 Provide first part of the key to infrastructure
225 Provide and transmit second part of the key to external location
230 Provide second part of the key to motor vehicle
300 Second method
305 Establish connection between motor vehicle and infrastructure
310 Authenticate bilaterally
315 Request function
320 Enable use of the function for enquirer?
325 Perform function

1.-10. (canceled)

11. A control system, comprising:
a motor vehicle with a first control apparatus;
an infrastructure with a second control apparatus;
wherein the first and second control apparatuses are configured to establish a wireless connection to one another and to carry out a bilateral authentication via the wireless connection,
wherein the motor vehicle is configured to request a predefined function of the infrastructure via the wireless connection, and
wherein the second control apparatus is configured to perform the requested predefined function of the infrastructure if the function is enabled for control by way of the motor vehicle.

12. The control system according to claim 11, wherein the function of the infrastructure relates to the motor vehicle.

13. The control system according to claim 11, wherein
the infrastructure is configured to request a predefined function of the motor vehicle via the wireless connection, and
the first control apparatus is configured to perform the requested predefined function of the motor vehicle if the function is enabled for control by way of the infrastructure.

14. The control system according to claim 11, wherein authenticating takes place via an asymmetric cryptographic method.

15. The control system according to claim 11, further comprising:
an external location, from which a public key of a participant is obtainable.

16. The control system according to claim 15, further comprising:
a mobile device,
wherein the mobile device is configured to establish a wireless connection to the infrastructure and to perform a bilateral authentication via the connection, and
wherein enabling of a function of the infrastructure is controlled with regard to a request by way of the motor vehicle via the wireless connection.

17. An apparatus, comprising:
an infrastructure control apparatus,
wherein the infrastructure control apparatus is configured to:
establish a wireless connection to a motor vehicle and to perform a bilateral authentication via the wireless connection;
receive a request of a motor vehicle via the wireless connection with regard to a function of the infrastructure; and
perform the requested function if the function is enabled for control by way of the motor vehicle.

18. The apparatus according to claim 17, further comprising:
an actuator for controlling a function of the infrastructure.

19. A method, comprising:
generating a two-part digital key;
providing a first part of the key to a motor vehicle;
providing a second part of the key to an infrastructure; and
performing a bilateral authentication between the motor vehicle and the infrastructure based on the first and second parts.

20. A method for controlling a predefined function of an infrastructure, the method comprising:
establishing a wireless connection between a motor vehicle and the infrastructure, including bilateral authenticating via the wireless connection;
requesting a predefined function of the infrastructure by way of the motor vehicle via the wireless connection; and
performing the predefined function by way of the infrastructure if the predefined function is enabled for control by way of the motor vehicle.
